(19) United States
(12) Patent Application Publication
(10) Pub. No.: US 2013/0340794 A1
(43) Pub. Date: Dec. 26, 2013

(54) THREADED PIPE CLEANING SYSTEM AND METHOD

(71) Applicant: Tony Flynn, Choctaw, OK (US)

(72) Inventor: Tony Flynn, Choctaw, OK (US)

(21) Appl. No.: 13/926,341

(22) Filed: Jun. 25, 2013

Related U.S. Application Data
(60) Provisional application No. 61/663,938, filed on Jun. 25, 2012.

(51) Int. Cl. B08B 9/032

(52) U.S. Cl. CPC B08B 9/0328
USPC 134/22.12; 134/99.1

(57) ABSTRACT

A pipe thread cleaning system includes an air delivery system, a fluid delivery system, and a thread cleaner having a housing. A pipe support assembly includes an inflatable seal associated with an open end of the housing. A fluid supply assembly includes a rotating stem having a first end positioned inside the housing and having a hub associated therewith, and a second end positioned outside of the housing. A wand is fluidly coupled with the hub and has a fist portion extending radially from the hub, and a second portion extending parallel to the sidewall and including an opening configured to direct a volume of cleaning fluid and gas onto threads of the threaded pipe. A handle is associated with the rotating stem and configured to rotate the rotating stem relative to the housing such that the wand directs a volume of cleaning fluid and gas towards the threads.

### INCORPORATION BY REFERENCE

This application claims priority to U.S. provisional application Ser. No. 61/663,938 filed Jun. 25, 2012, the entire disclosure of which is hereby incorporated herein by reference.

### BACKGROUND

Threaded pipes and other tubular members are used in many different industrial applications, such as flow lines, pipelines, various industrial conduits, mineral exploration and production, and oil well, gas well, and water well casings, drilling and production pipes and pipe strings.

The drilling and completion of oil and gas wells requires the use of multiple lengths of threaded pipes, which are joined together and assembled into what is called a pipe string, which pipe string may then be lowered into a bore hole, or used to transfer gas, liquids, or fluids, for example.

Threaded pipes have male (or external) threads formed in one end thereof, and female (or internal) threads formed in another end thereof. The external threads of threaded pipes are sometimes colloquially referred to as “pin,” and the matching internal threads are sometimes referred to as “box” or “coupling.”

To allow the two lengths of threaded pipe to be safely and securely joined together by threading the external threads of one pipe into the internal threads of another pipe. The external and internal threads of the two lengths of pipe should be free of dirt, debris, rust, or other contaminants, such that the pipes can be securely attached to one another. The resulting connection may be substantially leak-proof, to prevent any liquids, gasses, or other fluids from leaking out of the pipe string via the joints between two lengths of threaded pipe.

A lubricating and protecting compound known as “pipe dope” or “thread dope” may be used to protect the external and internal threads from corrosion and contaminants, and to lubricate the threaded joint between two lengths of threaded pipe. The pipe dope may be applied on the internal and external threads during transport, storage, or use of the pipes, such that a safe and substantially sealed joint is ensured between lengths of threaded pipe.

As various lengths of threaded pipe are transported, stored, transferred, and used in the field, the exposed threads, along with any pipe dope applied thereto, tend to accumulate various contaminants, such as rust, sand, dirt, mud, debris, oilfield materials, and other solid or liquid contaminants, which may cause the joint between two threaded pipes to be unsafe, or to allow fluid to seep from or into the interior of the pipes. Particulate and/or solid contaminants caught in the threads may also result in an improper joint, thread mismatch, or may cause stripping or other damage to the external and/or internal threads.

The prior art has attempted to clean exposed external and internal threads manually, or by using a variety of cumbersome, expensive devices, which are complicated to use and do not consistently clean the threads. Further, the contaminants and/or debris removed from the threads with prior art devices and cleaning methods are typically allowed to splash out of the device and may come into contact with the oilrig floor and/or oilfield personnel, for example. Such splashed contaminants may pose safety concerns for oilfield personnel, and may cause injuries, such as hand and eye injuries, for example.

The contaminants and pipe dope cleaned from the pipe threads may cause environmental harm if disposed of improperly, and may pose significant slip and fall and/or fire and explosion hazards for oilfield personnel. Further, prolonged exposure to such contaminants may have negative long-term consequences for the health of oilfield personnel.

Accordingly, a need exists in the prior art for a threaded pipe cleaning system and method that safely cleans the external and internal threads of threaded pipes and contains and safely disposes of the removed contaminants. It is to such a threaded pipe cleaning system and to a method of cleaning threaded pipes that the inventive concepts disclosed herein are directed.

### SUMMARY

In one aspect, the inventive concepts disclosed herein are directed to a pipe thread cleaning system. The system includes an air delivery system configured to deliver a volume of pressurized gas, a fluid delivery system configured to deliver a volume of pressurized fluid, and a thread cleaner. The thread cleaner includes a housing having an open end, a closed end, and a sidewall. A pipe support assembly includes an inflatable seal associated with the open end of the housing and fluidly coupled with the air delivery system. The inflatable seal is configured to substantially seal against an exterior of a threaded pipe when the threaded pipe is advanced into the housing. A fluid supply assembly includes a rotating stem extending through the closed end of the housing and having a first end positioned inside the housing, and a second end positioned at least partially outside of the housing and a hub associated therewith, the hub fluidly coupled with the fluid delivery system. A wand is fluidly coupled with the hub and has a first portion extending substantially radially from the hub and a second portion extending substantially parallel to the sidewall, the second portion including at least one jet opening configured to direct a volume of cleaning fluid onto threads of the threaded pipe when the threaded pipe is advanced into the housing. A handle is associated with the second end of the rotating stem and is configured to rotate the rotating stem relative to the housing so as to rotate the hub and the wand relative to the threads of the threaded pipe when the threaded pipe is advanced in the housing such that the wand directs a volume of cleaning fluid towards substantially an entire surface of the threads of the threaded pipe.

The fluid supply assembly may also include an air conduit fluidly coupled with the air delivery system and extending at least partially past the first end of the rotating stem. The air conduit may have an air-jetting head configured to extend into the threaded pipe when the threaded pipe is advanced into the housing, the air-jetting head having one or more air jetting openings configured to jet a volume of pressurized gas towards the closed end of the housing.

The pipe support assembly may also include an air jetting ring positioned below the inflatable seal and fluidly coupled with the air delivery system, the air jetting ring having at least one air-jetting outlet configured to jet a volume of pressurized gas towards the closed end of the sidewall.

The pipe support assembly may also include a support gusset positioned inside the housing and configured to support and end of the threaded pipe when the threaded pipe is advance into the housing. The pipe support assembly may include an alignment spider assembly including an internal finger guide. The internal finger guide may have a parallel portion configured to be inserted at least partially into the threaded pipe when the threaded pipe is advanced into the housing and having a support portion configured to support and end of the threaded pipe, and a radial portion rotatably associated with the rotating stem. The radial portion may be an adjustable-length radial portion.

The pipe support assembly may include an internal sealing assembly having a support connected to the hub, and a seal member rotatably connected to the support and configured to be at least partially inserted into the threaded pipe as the threaded pipe is advanced into the housing so as to substantially seal an interior of the threaded pipe. The sealing member may include a sidewall, a flange extending laterally from the sidewall, and an elastomeric seal positioned adjacent to the flange. The internal sealing assembly may extend past the open end of the sidewall.

The rotating stem may include a fluid manifold coupled with the second end thereof, the fluid manifold including and air chamber fluidly coupled with the air delivery system, and a cleaning fluid chamber fluidly coupled with the fluid delivery system, the fluid manifold fluidly coupled with the hub and with the at least one wand such that at least one of a volume of pressurized cleaning fluid and a volume of pressurized gas flows through the at least one wand. The system air chamber may be fluidly coupled with the air delivery system via a check valve.

The housing may include a drain configured to drain a volume of cleaning fluid from the housing. The drain may be fluidly coupled with the fluid delivery system. The rotating stem may be rotatable relative to the housing between about 0° and about 720°.

In another aspect, the inventive concepts disclosed herein are directed to a method of cleaning pipe threads. The method includes advancing a threaded pipe having threads into an open end of a housing and towards a closed end of the housing. The method also includes inflating an inflatable seal associated with a sidewall of the housing adjacent to the open end such that the inflatable seal substantially seals against an exterior of the threaded pipe. The method further includes jetting a volume of pressurized cleaning fluid towards the threads of the threaded pipe via a jet opening of a wand extending substantially parallel to the sidewall of the housing. The method may also include rotating the wand relative to the threads by rotating a rotatable stem assembly having a rotatable hub associated with a first end thereof and with the at least one wand, and a second end extending at least partially outside the closed end of the housing and having a handle, wherein the at least one wand is fluidly coupled with the hub and the hub is fluidly coupled with a cleaning fluid delivery system and a gas delivery system. The method further includes draining the volume of pressurized cleaning fluid via a drain fluidly coupled with the housing, and jetting a volume of pressurized gas towards the threads via the at least one wand so as to substantially dry the threads and to enhance cleaning fluid drainage via the drain.

The step of rotating the at least one wand may include rotating the at least one wand between about 0° and about 720° relative to the threads so as to direct pressurized cleaning fluid toward substantially an entire surface of the threads.

The method may also include inserting an internal sealing assembly at least partially into an interior of the threaded pipe such that the internal sealing assembly substantially seals the interior of the threaded pipe so as to substantially prevent pressurized cleaning fluid and pressurized gas from flowing into the interior of the threaded pipe and past the internal sealing assembly.

The method may include jetting a volume of pressurized air via an air-jetting ring associated with the sidewall below the inflatable seal and fluidly coupled with an air delivery system, so that the volume of pressurized gas moves along the threaded pipe and towards the closed end of the housing so as to generate a positive pressure inside the housing.

The method may also include jetting a volume of pressurized gas towards the closed end of the housing via an air jetting opening of an air jetting head supported by an air conduit extending through the rotating stem such that the air jetting head is at least partially positioned inside the threaded pipe, so that pressurized cleaning fluid is substantially prevented from flowing inside the threaded pipe.

### BRIEF DESCRIPTION OF THE DRAWINGS

Like reference numerals in the figures represent and refer to the same or similar element or function. Implementations of the inventive concepts disclosed herein may be better understood when consideration is given to the following detailed description thereof. Such description makes reference to the annexed pictorial illustrations, schematics, graphs, drawings, and appendices. In the drawings:

FIG. 1 is a diagram of a threaded pipe cleaning system according to the inventive concepts disclosed herein.

FIG. 2 is a cross-sectional view of an embodiment of an internal thread cleaner according to the inventive concepts disclosed herein, with a threaded pipe shown inserted therein.

FIG. 3 is a perspective view of the internal thread cleaner of FIG. 2, with the housing not shown for clarity.

FIG. 4 is a perspective view of the internal components of the internal thread cleaner of FIG. 3.

FIG. 5 is a cross-sectional view of an exemplary embodiment of an external thread cleaner according to the inventive concepts disclosed herein with a threaded pipe shown inserted therein.

FIG. 6 is a perspective view of the external thread cleaner of FIG. 5, with the housing not shown for clarity.

FIG. 7 is a perspective view of the internal components of the external thread cleaner of FIG. 6.

FIG. 8 is a diagram of an exemplary embodiment of a threaded pipe cleaning system according to the inventive concepts disclosed herein.

FIG. 9 is a cross-sectional view of an embodiment of an internal thread cleaner according to the inventive concepts disclosed herein, with a threaded pipe shown inserted therein.

FIG. 10 is a diagram of an exemplary embodiment of a fluid manifold according to the inventive concepts disclosed herein.

FIG. 11 is a cross-sectional view of an exemplary embodiment of an external thread cleaner according to the inventive concepts disclosed herein with a threaded pipe shown inserted therein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting.

In the following detailed description of embodiments of the inventive concepts disclosed herein, numerous specific details are set forth in order to provide a more thorough understanding of the inventive concepts disclosed herein. However, it will be apparent to one of ordinary skill in the art that the inventive concepts disclosed herein may be practiced without these specific details. In other instances, well-known features have not been described in detail to avoid unnecessarily complicating the instant disclosure.

As used herein the notation “a-n” appended to a reference numeral is intended as merely convenient shorthand to reference one, or more than one, and up to infinity, of the element or feature identified by the respective reference numeral (e.g., 100a-n). Similarly, a letter following a reference numeral is intended to reference an embodiment of the feature or element that may be similar, but not necessarily identical, to a previously described element or feature bearing the same reference numeral (e.g., 100, 100a, 100b, etc.). Such shorthand notations are used for purposes of clarity and convenience only, and should not be construed to limit the inventive concepts disclosed herein in any way, unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

As used herein the qualifiers “about,” “approximately,” and “substantially” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The inventive concepts disclosed herein are directed to threaded pipe cleaning systems and to methods of cleaning internal and external pipe threads using threaded pipe cleaning systems.

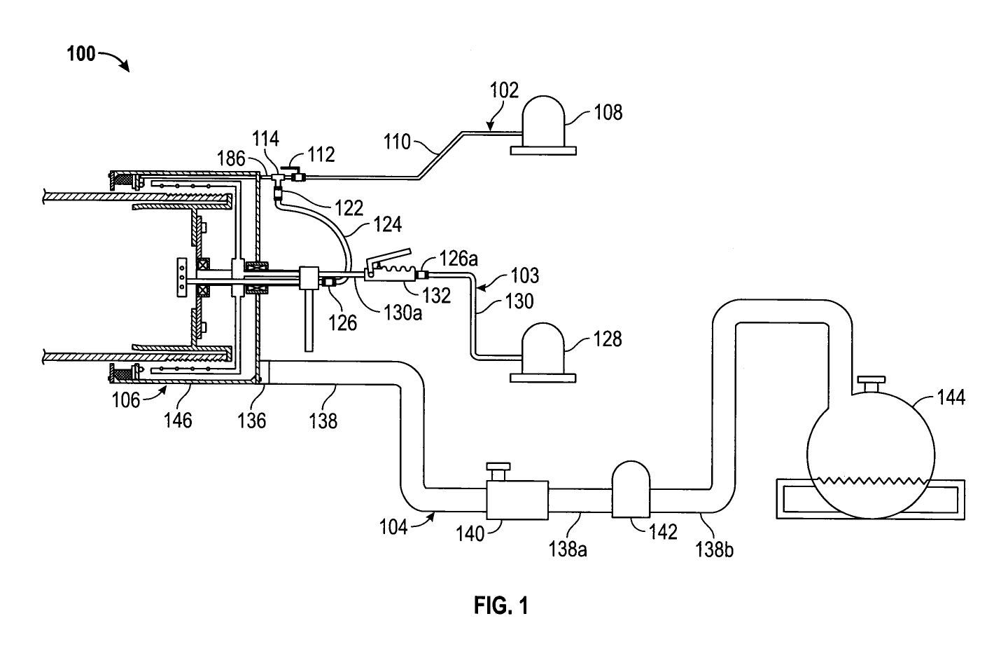

Referring now to FIG. 1, an exemplary embodiment of a threaded pipe cleaning system 100 according to the inventive concepts disclosed herein may include an air delivery system 102, a fluid delivery system 103, a drain system 104, and a thread cleaner 106.

The air delivery system 102 may include an air compressor 108, which may be implemented as a 120-pounds-per-square-inch (psi) air compressor 108 in some exemplary embodiments of the inventive concepts disclosed herein. It is to be understood that any desired size and type of air compressor 108 may be implemented with the inventive concepts disclosed herein. Further, the air compressor 108 may compress any gas, liquid, or fluid, such as air, nitrogen, inert gasses, carbon dioxide, steam, and combinations thereof, for example. Two or more than two air compressors 108 may be implemented with some exemplary embodiments of the inventive concepts disclosed herein, while in other exemplary embodiments the air compressor 108 may be omitted and replaced with a pressurized vessel (not shown) containing a pressurized fluid. Further, in some embodiments one or more air compressors 108 and one or more pressurized fluid-storing vessels may be implemented, for example.

The air compressor 108 may be fluidly connected with an air supply conduit 110 which may be implemented as any conventional air supply conduit 110 capable of withstanding the pressure supplied by the air compressor 108, for example. The air supply conduit 110 may be fluidly connected with a valve 112, which may be implemented as any suitable valve 112 capable of selectively partially or completely closing and partially of completely opening the air supply conduit 110, such that the flow of air or other fluid through the air supply conduit 110 may be regulated by the valve 112. In some exemplary embodiments the valve 112 may be implemented as a ball valve 112, while in other exemplary embodiments the valve 112 may be implemented as a solenoid, a pressure regulator, a foot operated valve, or any other conventional valve, and combinations thereof. Further, in some exemplary embodiments of the inventive concepts disclosed herein two or more air supply conduits 110 and/or two or more valves 112 may be implemented, as will be appreciated by persons of ordinary skill in the art having the benefit of the instant disclosure.

The valve 112 may be fluidly connected with an air manifold 114, such that the air manifold 114 may supply air to the thread cleaner 106 as will be described below. The air manifold 114 may include an adjustable airflow restrictor valve 122, which may regulate airflow to the thread cleaner 106 as will be described below. The airflow restrictor valve 122 may be implemented as any conventional airflow restrictor valve 122, and more than one airflow restrictor valve 122 may be implemented in some exemplary embodiments of the inventive concepts disclosed herein. An air conduit 124 may be used to supply air to the thread cleaner 106 as will be described below. The air conduit 124 may be fitted with an optional swivel 126 to allow rotation of the air conduit 124.

The fluid delivery system 103 may include a high-pressure fluid pump 128 which may supply pressurized cleaning fluid to the thread cleaner 106 as will be described below. The fluid pump 128 may be implemented as any conventional fluid pump 128, and may generate any desired pressure, such as a pressure ranging from about 0 psi to about 5000 psi, or higher. Cleaning fluid may be supplied to the fluid pump 128 from a cleaning fluid storage tank (not shown) having any desired capacity related to the projected duration and volume of cleanup operations, or relating to the capacity of the used cleaning fluid holding tank as will be described below, for example. Alternatively, cleaning fluid may be supplied to the fluid pump 128 from a conventional plumbing installation, from a water well, from a water tanker truck, and combinations thereof, for example.

The fluid pump 128 may be in fluid communication with a high-pressure fluid conduit 130, which may be implemented as any suitable fluid conduit 130 capable of withstanding the pressure supplied by the fluid pump 128, such as a half-inch high-pressure flexible hose, or any other suitable fluid conduit 130, for example. The fluid conduit 130 may be fluidly connected to a high-pressure trigger valve 132 via a swivel 126a. The swivel 126a may function to allow the fluid conduit 130 and the trigger valve 132 to swivel relative to one another, while maintaining a substantially fluidly impermeable connection between the fluid conduit 130 and the trigger valve 132.

The trigger valve 132 may be implemented as any conventional trigger valve 132 (e.g., a hand or foot operated valve) allowing a user to completely or partially allow or prevent a fluid from flowing through the trigger valve 132, for example. It is to be understood that while a mechanically controlled trigger valve 132 is shown in FIG. 1, the inventive concepts disclosed herein may be implemented with any suitable trigger valve 132, which may be manually, electronically, mechanically, hydraulically, pneumatically, magnetically, or remotely actuated, and combinations thereof, for example.

Cleaning fluid may be supplied, fed into, pumped, or otherwise provided to the thread cleaner 106 via a high-pressure fluid conduit 130a, which may be fluidly connected to the trigger valve 132 and to the thread cleaner 106, for example. The high-pressure fluid conduit 130a may be implemented similarly to the fluid conduit 130, for example.

Cleaning fluid according to exemplary embodiments of the inventive concepts disclosed herein may be any conventional cleaning fluid, solution, or mixture of fluids, such as water, steam, alcohols, organic chemicals, inorganic chemicals, degreasers, detergents, surfactants, organic solvents, petrochemicals, and combinations thereof. In some exemplary embodiments, the cleaning fluid may be heated to any desired temperature, including evaporating or superheating, while in other exemplary embodiments the cleaning fluid may be supplied at ambient temperatures. Further, various chemical additives may be added to the cleaning fluid, such as pH buffers, flame-retardant chemicals, acids, bases, biocidal chemicals, and combinations thereof. In some exemplary embodiments, various particulate additives, such as sand, quartz crystals, or other granular or particulate materials may be added to the cleaning fluid, as will be understood by persons of ordinary skill in the art.

The drain system 104 may include a coupling 136 which may be fluidly connected with the thread cleaner 106 by a male end of the coupling 136, for example. The coupling 136 may be implemented as any conventional coupling 136 with any desired size, such as a one and one-half inch quick coupling 136, for example. A female end of the coupling 136 may be fluidly connected with a low-pressure drain conduit 138, which may be implemented as a one and one-half inch low-pressure flexible hose, or as any other suitable size conduit, for example. The drain conduit 138 may be fluidly connected to an inlet side of a settling tank 140. It is to be understood, that in some exemplary embodiments the settling tank 140 may be vented to the atmosphere, or vented to a flare line, while in other exemplary embodiments the settling tank 140 may be substantially sealed and not vented. Further, in some exemplary embodiments, more than one settling tank 140 may be implemented, such as two or more settling tanks 140 connected in series or in parallel to one another, and combinations thereof. Further, in some exemplary embodiments of the inventive concepts disclosed herein, the settling tank 140 may be omitted. The settling tank 140 may function to allow solids to separate from the used cleaning fluid under gravity, and may optionally include on or more chambers (not shown), impingement plates (not shown), baffles (not shown), clean out access openings (not shown), and combinations thereof, for example. In some exemplary embodiments of the inventive concepts disclosed herein, the settling tank 140 may be implemented as a two-phase or three-phase separator, capable of separating solids, liquids, and/or gasses from one another. Any solids settled into the settling tank 140 may be periodically removed and disposed of in any suitable manner, for example.

A drain conduit 138a may be fluidly connected to an outlet side of the settling tank 140 and to a pump 142. The pump 142 may be fluidly connected to a used cleaning fluid holding tank 144 via a drain conduit 138b. The pump 142 may be implemented as any conventional pump 142 capable of pumping cleaning fluid from the settling tank 140 to the used cleaning fluid holding tank 144 via the drain conduits 138a and 138b respectively, for example.

The holding tank 144 may be implemented as any conventional holding thank 144, and may be vented to the atmosphere or to a flare line, or may be un-vented, for example. The holding tank 144 desirably has the capacity to hold a sufficient amount of used cleaning fluid to allow the threaded pipe cleaning system 100 to operate continuously or intermittently for certain duration of time related to the size of the threaded pipe cleaning system 100, for example. In some exemplary embodiments, the holding tank 144 may be implemented as a 250 gallon holding tank 144, which may be mounted on a trailer, on a skid, or on a truck, and combinations thereof. In some exemplary embodiments, the holding tank 144 may be implemented as a tanker truck, as will be appreciated by persons of ordinary skill in the art, allowing the holding tank 144 to be taken off-site for safe disposal of the used cleaning fluid. In some exemplary embodiments of the inventive concepts disclosed herein, the used cleaning fluid may be recycled through the threaded pipe cleaning system 100 one or more times, or may be otherwise disposed of on-site, and combinations thereof.

The thread cleaner 106 may be selectively configured as an internal thread cleaner 106a or an external thread cleaner 106b as will be described herein below.

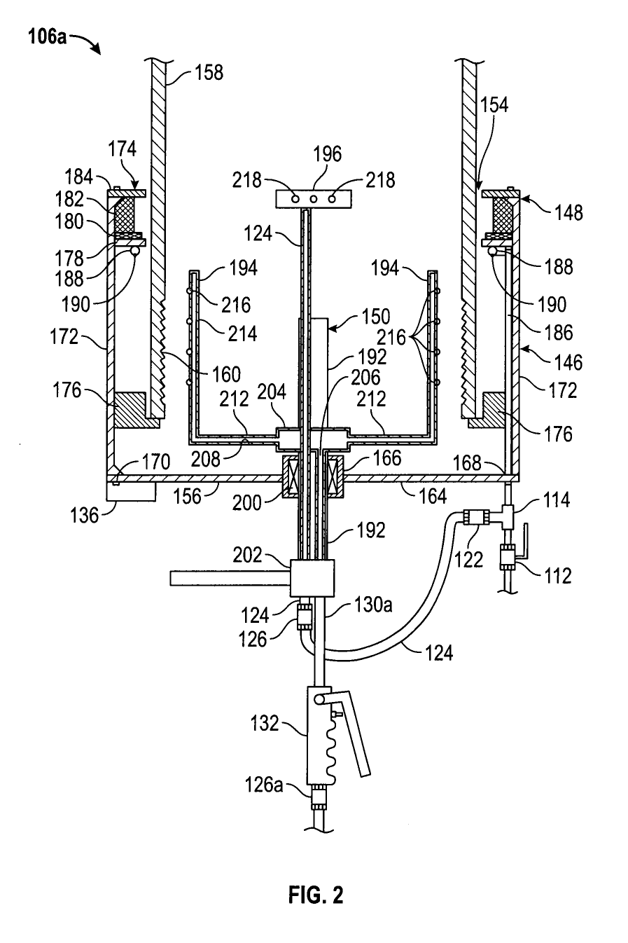

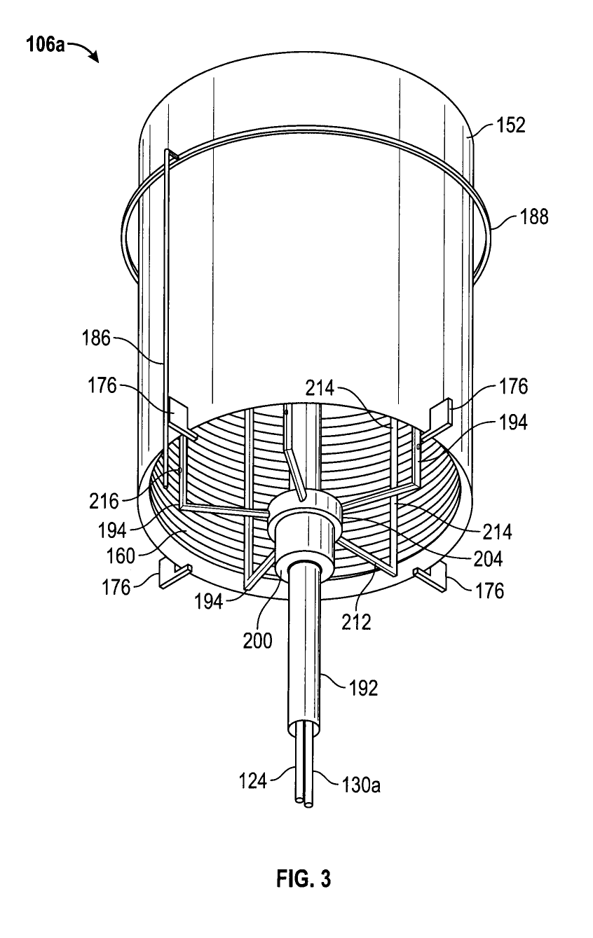

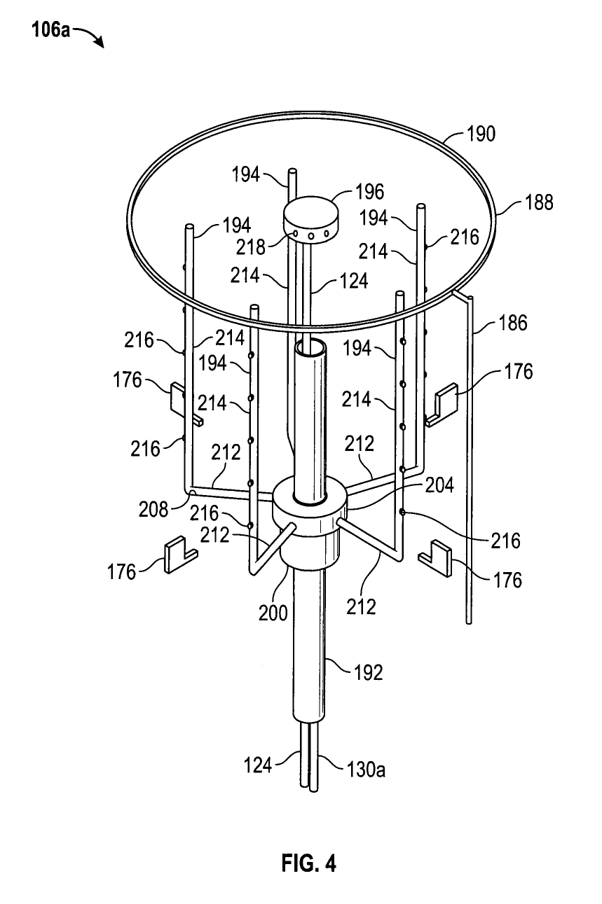

Referring now to FIGS. 2-4, shown therein is an exemplary embodiment of an internal thread cleaner 106a according to the inventive concepts disclosed herein. The internal thread cleaner 106a may include a housing 146, a pipe support assembly 148, and a fluid supply assembly 150.

The housing 146 may have an open end 154 and a closed end 156. The housing 146 may be substantially cylindrical in shape, and may have various sizes depending on the size of threaded pipe 158 the housing 146 is used with. The housing 146 may be constructed of any suitable material, such as metals, alloys, non-metals, plastics, resins, steel, wood, composite materials, and combinations thereof, for example. It is to be understood that in some exemplary embodiments, the housing 146 may have any desired shape, such as being triangular, oval, square, rectangular, pentagonal, etc.

The open end 154 of the housing 146 may be configured to receive an end of the threaded pipe 158 therein, such that the internal threads 160 of the threaded pipe 158 are at least partially inserted into the open end 154 of the housing 146, for example. In some exemplary embodiments of the inventive concepts disclosed herein, the internal threads 160 of the threaded pipe 158 may be substantially completely inserted into the open end 154 of the housing 146.

The closed end 156 of the housing 146 may include a substantially cylindrical endwall 164, although the endwall 164 may have any desired shape, such as oval, square, hexagonal, octagonal, triangular, and combinations thereof, for example. The endwall 164 may include a central opening 166, an air conduit opening 168 radially offset from the central opening 166, and a drain opening 170 radially offset from the central opening 166.

The drain system 104 may be in fluid communication with the housing 146 via the drain opening 170 to permit the draining of the used cleaning fluid from the housing 146 by the drain system 104 (FIG. 1) as will be described below. For example, the coupling 136 may be attached to the end wall 164, such that the drain conduit 138 (FIG. 1) is in fluid communication with the drain opening 170. An optional sump (not shown) may be implemented with the drain opening 170 in some exemplary embodiments of the inventive concepts disclosed herein, to facilitate drainage of the cleaning fluid from the housing 146.

A sidewall 172 may extend between the open end 154 and the closed end 156 of the housing 146, and may be connected to the end wall 164 in substantially fluid-impermeable manner. It is to be understood that in some exemplary embodiments of the inventive concepts disclosed herein, the sidewall 172 and the end wall 164 may be formed as a unitary body.

The pipe support assembly 148 may include an inflatable seal assembly 174 and one or more alignment gussets 176 extending from the sidewall 172 and into the housing 146 to define a guide path and to stabilize the threaded pipe 158 when the threaded pipe 158 is inserted into the housing 146.

The inflatable seal assembly 174 extends about the sidewall 172 at the open end 154 of the housing and may include a backing plate 178, a removable spacer ring 180, an inflatable seal 182, and an end plate 184.

The backing plate 178 may extend substantially perpendicularly from the sidewall 172 and into the cylindrical housing 146 and may function to support an inner side of the inflatable seal 182. The backing plate 178 may be permanently or removably attached to the sidewall 172 in any suitable manner, such as via bolts, screws, adhesives, welds, seams, brackets, and combinations thereof, for example. In some exemplary embodiments of the inventive concepts disclosed herein, the backing plate 178 and the sidewall 172 may be formed as a unitary body. The backing plate 178 may be constructed of any suitable material, such as stainless steel, titanium, plastics, resins, alloys, metals, non-metals, and combinations thereof, for example, and may extend from the sidewall 172 at any angle from about 0° to about 180°.

The removable spacer ring 180 may be positioned between the backing plate 178 and the inflatable seal 182. The removable spacer ring 180 may be attached to the backing plate 178 and/or to the inflatable seal 182 in any desired manner, for example. The removable spacer ring 180 may be available in various sizes to support different sizes of the inflatable seal 182, so that the internal thread cleaner 106a can be utilized with different sizes of threaded pipe 158. The removable spacer ring 180 may be constructed from a variety of materials, such as fibrous materials, plastics, resins, composite materials, metals, non-metals, alloys, and combinations thereof. It is to be understood that the removable spacer ring 180 may be omitted in some exemplary embodiments of the inventive concepts disclosed herein.

The inflatable seal 182 may be implemented as any conventional inflatable seal 182 and may be sized such that the inflatable seal 182 does not extend into the housing 146 past the backing plate 178 when deflated, and extends into the housing 146 at least partially past the backing plate 178 when inflated, for example. The inflatable seal 182 may extend about 360° about the open end 154 of the housing 146, for example. The inflatable seal 182 may be in fluid communication with an air supply conduit 186 which may extend through the removable spacer ring 180 and through the backing plate 178. The air supply conduit 186 may extend internally along the length of the sidewall 172 and may exit the housing 146 through the air conduit opening 168 of the end wall 164. The air supply conduit 186 may be fluidly connected to the air manifold 114, such that pressurized air may be supplied to the air supply conduit 186 via the air manifold 114. The air supply conduit 186 may be implemented as any conventional air supply conduit.

The air supply conduit 186 may be fluidly connected to an optional air-jetting ring 188, such that pressurized air may be supplied to the optional air-jetting ring 188 via the air supply conduit 186. In an exemplary embodiment of the inventive concepts disclosed herein, the optional air-jetting ring 188 may be implemented as a ⅜″ conduit extending about 360° around the housing 146, such that the optional air-jetting ring 188 is positioned between the threaded pipe 158 and the sidewall 172 and below the inflatable seal assembly 174 when the threaded pipe 158 is inserted into the housing 146. The optional air-jetting ring 188 may have one or more air-jetting outlet 190, which one or more air-jetting outlet 190 may be oriented such that air is discharged from the one or more air-jetting outlet 190 substantially toward the closed end 156 of the housing 146, for example. The optional air-jetting ring 188 may function to supply positive pressure (i.e., any pressure higher than atmospheric pressure) around the outside threaded pipe 158, such that the positive pressure may assist in moving the cleaning fluid out toward the drain opening 170 as will be described below.

The end plate 184 may be removably connected to (e.g., bolted) to the sidewall 172 to support an outer side of the inflatable seal 182. The end plate 184 may be implemented in various sizes to allow the internal thread cleaner 106a to be use with various sizes of threaded pipe 158, for example. It is to be understood that while the end plate 184 is shown as being substantially similar in size to the backing plate 178, in some exemplary embodiments of the inventive concepts disclosed herein the end plate 184 and the backing plate 178 may have different sizes.

It is to be understood that in some embodiments of the inventive concepts disclosed herein, two or more than two inflatable seal assemblies 174 may be implemented, and such two or more inflatable seal assemblies 174 may be positioned adjacent to one another along the sidewall 172, or may be offset a certain distance from one another along the sidewall 172, and combinations thereof, for example.

The one or more alignment gussets 176 may be removably attached to the sidewall 172 such that the one or more alignment gussets 176 extend substantially perpendicularly from the sidewall 172 into the housing 146, and the one or more alignment gussets 176 are offset a distance from the one or more in flatable seal assembly 174 along the sidewall 172, for example. The one or more alignment gussets 176 may be constructed of any suitable material, such as rubber, elastomeric materials, resilient plastics, metals, thermoset materials, non-metals, and combinations thereof, for example. The one or more alignment gussets 176 may be removably attached to the sidewall 172 in any desired manner, such as bolts, screws, brackets, clamps, and combinations thereof, for example. The one or more alignment gussets 176 may taper from the open end 154 to the closed end 156 of the housing 146 to allow for easier insertion of the threaded pipe 158 into the housing 146, for example. The one or more alignment gussets 176 may have any desired shape and size, and may define a portion of a cylindrical surface configured to mate with the threaded pipe 158 in some exemplary embodiments of the inventive concepts disclosed herein.

The one or more alignment gussets 176 may be designed to support the threaded pipe 158 when the threaded pipe 158 is inserted into the housing 146, and to align the threaded pipe 158 with the sidewall 172 as the threaded pipe 158 is inserted into the housing 146, for example. The one or more alignment gussets 176 may be changed out to allow for different sizes of threaded pipe 158 to be used with the same internal thread cleaner 106a, for example. In some exemplary embodiments of the inventive concepts disclosed herein only a single alignment gusset 176 may be implemented, while in other exemplary embodiments, two, three, four, five, six, seven, or more alignment gussets 176 may be implemented, and such alignment gussets 176 may be spaced symmetrically or un-symmetrically about the sidewall 172.

The fluid supply assembly 150 may include a rotating stem 192, one or more wands 194, and an air-jetting head 196.

The rotating stem 192 may rotatably extend at least partially through the central opening 166 of the end wall 164, such that a first end of the rotating stem 192 is positioned internally to the housing 146, and a second end of the rotating stem 192 is positioned externally to the housing 146. The rotating stem 192 may be constructed of any suitable material, such as metals, alloys, resilient plastics, non-metals, resins, and combinations thereof, for example. An optional sealed bearing 200 may be implemented to ensure smooth rotation of the rotating stem 192 about the end wall 164, while maintaining a substantially fluid-impermeable connection between the end wall 164 and the rotating stem 192, for example. The optional sealed bearing 200 may be implemented as any conventional sealed bearing 200 as will be understood by persons of ordinary skill in the art, and may include an optional protective housing, as will be understood by persons of ordinary skill in the art. The optional sealed bearing 200 may be removable for replacement and/or maintenance as needed.

The second end of the rotating stem 192 that is external to the housing 146 may be fitted with a handle 202 configured to allow a user to rotate the rotating stem 192 relative to the end wall 164, for example. In some exemplary embodiments, the handle 202 may include one or more optional stops or limiters (not shown) configured to limit the rotation of the handle 202 to about 90°, or to any other desired value. It is to be understood that the inventive concepts disclosed herein are not limited to the handle 202 being rotatable about 90°, and a handle 202 may be rotatable from about 0° to about 720°, for example. The handle 202 may be manually operated, mechanically operated, electronically operated, hydraulically operated, pneumatically operated, remotely controlled, and combination thereof, for example.

A substantially cylindrical hub 204 may be attached to the rotating stem 192. The hub 204 may be attached to the rotating stem 192 in any suitable manner, such as via a threaded coupling (shown), for example, or via any other conventional mechanism. The hub 204 may define an opening 206 (FIG. 2) and one or more internal fluid paths 208 (FIG. 2). The high-pressure fluid conduit 130a may extend through the rotating stem 192 and may be in fluid communication with the one or more internal fluid paths 208 of the hub 204, such that pressurized cleaning fluid may be supplied to the internal fluid paths 208 of the hub 204 via the high-pressure fluid conduit 130a, for example. In some exemplary embodiments of the inventive concepts disclosed herein, the hub 204 and the rotating stem 192 may be formed as a unitary body.

One or more wand 194 may extend from the hub 204, such that the one or more wand 194 is in fluid communication with the one or more internal fluid paths 208. The one or more wand 194 may be substantially L-shaped and may have one or more radial portions 212 extending substantially radially from the hub 204, and one or more parallel portions 214 extending substantially parallel to the sidewall 172 and to the internal threads 160 when the threaded pipe 158 is inserted into the housing 146, for example.

The one or more parallel portions 214 may have one or more jet openings 216 formed therein. The one or more jet openings 216 may be implemented as any conventional jet openings 216, may have any desired shape and size, and may be oriented at any angle (e.g., from about 0° to about 360°) relative to the one or more parallel portions 214. The one or more jet openings 216 may be offset from one another along the one or more parallel portions 214, such that substantially the entire surface of the internal threads 160 may be impinged upon or contacted by the cleaning fluid emitted from the one or more jet openings 216, for example. The one or more jet openings 216 may be configured and oriented to jet, emit, discharge, or otherwise supply pressurized cleaning fluid in a direction substantially perpendicular to the internal threads 160 in some exemplary embodiments of the inventive concepts disclosed herein. It is to be understood that the cleaning fluid may be jetted onto the internal threads 160 at any desired angle varying from about 0° to about 180°, for example.

It is to be understood that the one or more wand 194 may have any suitable shape, size, and orientation, provided that the one or more wand 194 is capable of cleaning the internal threads 160 by jetting high-pressure cleaning fluid onto the internal threads 160 as the hub 204 is rotated by operating the handle 202 as will be described below, for example. Some exemplary embodiments of the inventive concepts may include two, three, four, five, six, or a plurality of wands 194, and such multiple wands 194 may be oriented symmetrically or un-symmetrically about the hub 204, for example. The one or more wand 194 may be changed out to allow for different sizes of threaded pipes 158 to be cleaned with the internal thread cleaner 106a, for example.

The air conduit 124 may extend through the rotating stem 192 and at least partially through the opening 206 and into the housing 146, for example. The air conduit 124 may be in fluid communication with an air-jetting head 196. The air-jetting head 196 may have one or more air jetting openings 218 in fluid communication with the air conduit 124 and positioned such that pressurized air supplied by the air manifold 114 air may be jetted by the air-jetting head 196 substantially towards the end wall 164, for example. The air jetted into the housing 146 by the air-jetting head 196 may substantially prevent cleaning fluid from flowing inside the threaded pipe 158 and may assist in moving the used cleaning fluid toward the drain opening 170 by creating a positive pressure inside the housing 146 as will be described below, for example.

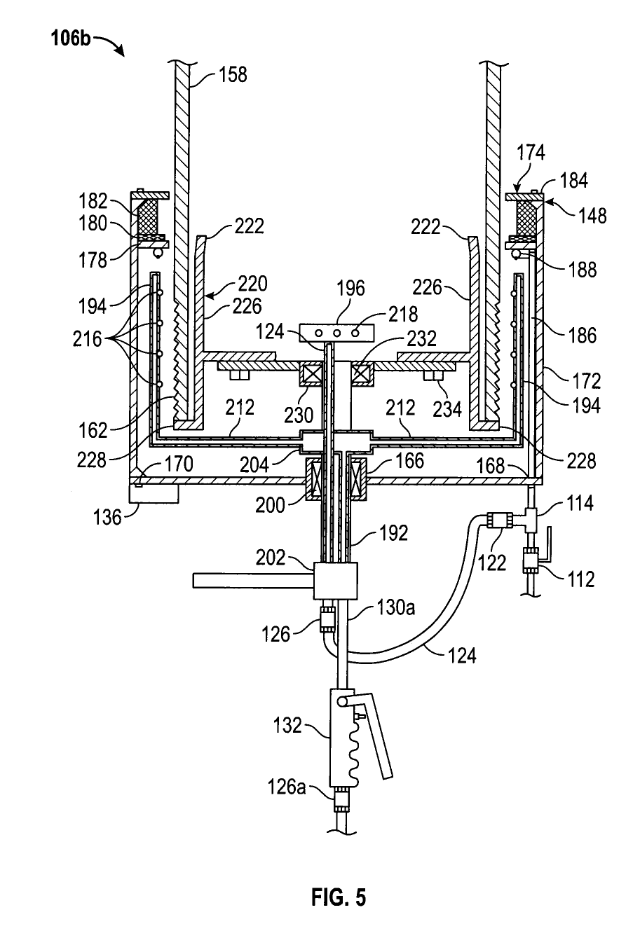

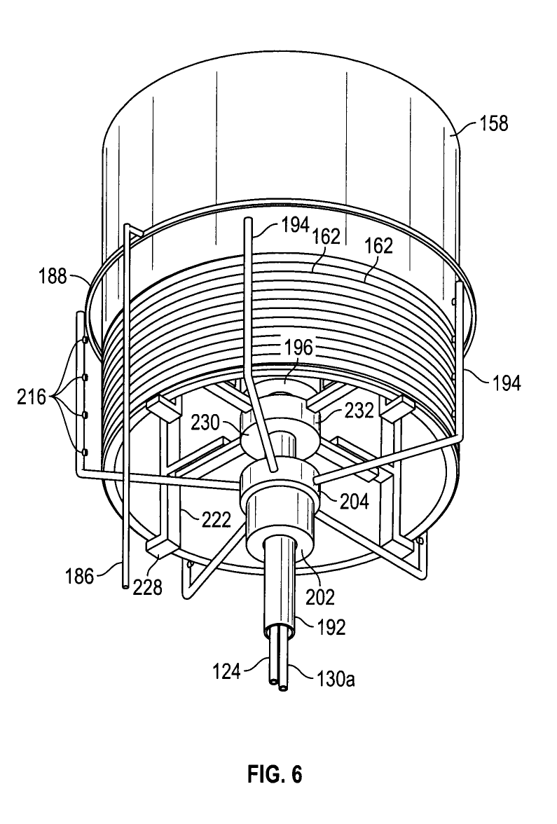

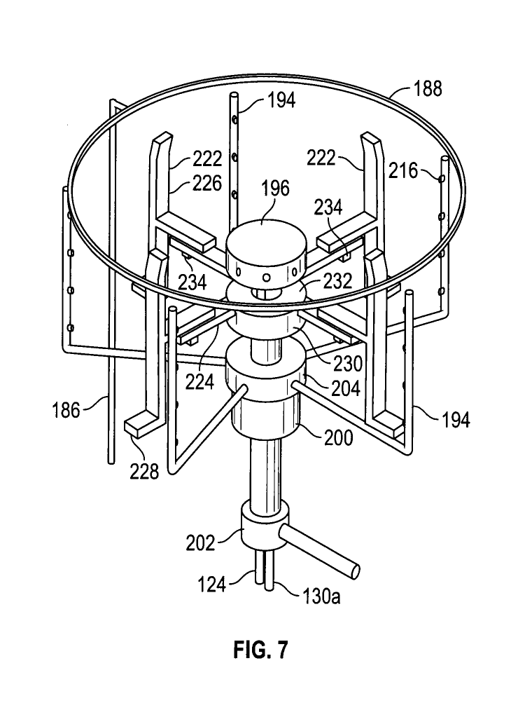

Referring now to FIGS. 5-7, shown therein is an exemplary embodiment of an external thread cleaner 106b according to the inventive concepts disclosed herein. The external thread cleaner 106b may be implemented similarly to the internal thread cleaner 106a, except that an alignment spider assembly 220 is implemented in place of the one or more alignment gussets 176.

The alignment spider assembly 220 may include one or more internal finger guides 222. The one or more internal finger guides 222 may have one or more radial portions 224 and one or more parallel portions 226 extending substantially parallel to the threaded pipe 158 when the threaded pipe 158 is inserted into the housing 146, for example. The parallel portions 226 may include one or more support portions 228, configured to limit the movement of the threaded pipe 158 into the housing 146 and to define the maximum distance to which the threaded pipe 158 may be inserted into the housing 146, for example.

The one or more radial portions 224 may extend radially from a common hub 230 which may be rotatably attached to the first end of the rotating stem 192 via a sealed bearing 232, for example. The sealed bearing 232 may allow rotation of the rotating stem 192 separately substantially without friction from the one or more internal finger guides 222, such that the alignment spider assembly 220 may remain substantially stationary as the rotating stem 192 is rotated as will be described below. The sealed bearing 232 may be implemented similarly to the optional sealed bearing 200 described above.

The one or more parallel portions 226 may be attached to the one or more radial portions 224 via one or more adjustment bolts 234 which may allow the one or more parallel portions 226 to be slidably movable in a radial direction relative to the one or more radial portions 224. The one or more internal finger guides 222 may be adjusted by loosening the one or more adjustment bolts 234 on the alignment spider assembly 220 to lengthen or shorten the radius of the one or more internal finger guides 222. It is to be understood that in some exemplary embodiments of the inventive concepts disclosed herein, the one or more internal finger guides 222 may be incrementally adjustable, such as by removing the adjustment bolts 234 from one or more first apertures (not shown), and inserting the one or more adjustment bolts 234 through one or more second apertures (not shown). In other embodiments, the one or more internal finger guides 222 may be adjustable by loosening the one or more adjustment bolts 234, sliding the one or more parallel portions 226 relative to the one or more radial portions 224, and tightening the adjustment one or more adjustment bolt 234, for example. In some exemplary embodiments, one or more visual markings, such as scale, notches, or alignment marks may be implemented to assist in the symmetrical adjustment of the radius of the one or more internal finger guides 222 as will be appreciated by a person of ordinary skill in the art.

The one or more internal finger guides 222 may function to align the threaded pipe 158 and the external thread cleaner 106b while inserting the threaded pipe 158 into the housing 146 and may also provide support for the external thread cleaner 106b during the cleaning mode of the external thread cleaner 106b, for example. The one or more internal finger guides 222 may allow the threaded pipe 158 to be inserted into the housing 146 substantially without obstruction from the face of the threaded pipe 158, and may provide stabilization of the threaded pipe 158 into the housing 146, while the external thread cleaner 106b is in place, such that the external threads 162 of the threaded pipe 158 are at least partially inserted into the open end 154 of the housing 146, for example. In some exemplary embodiments of the inventive concepts disclosed herein, the external threads 162 of the threaded pipe 158 may be substantially completely inserted into the open end 154 of the housing 146. The one or more internal finger guides 222 can be adjusted to allow for the external thread cleaner 106b to be used for various sized threaded pipe 158.

It is to be understood that the inventive concepts disclosed herein may be implemented with any number of internal finger guides 222, such as one, two three, four, five, or more than five internal finger guides 222, for example. In some exemplary embodiments, the one or more internal finger guides 222 may be arcuate in shape, or may define a portion of a cylindrical shape configured to mate with the cylindrical shape of the threaded pipe 158.

The alignment spider assembly 220 may be constructed of any suitable material such as steel, titanium, metals, alloys, non-metals, resilient materials, rubber, plastics, and combinations thereof, for example.

As will be understood by persons of ordinary skill in the art, the internal thread cleaner 106a may be converted to an external thread cleaner 106b by removing the one or more alignment gussets 176 and installing the alignment spider assembly 220 as described herein. The size of the one or more wand 194 may have to be varied accordingly, as will be appreciated by persons of ordinary skill in the art having the benefit of the instant disclosure.

The operation of the threaded pipe cleaning system 100 will be described herein with reference to the internal thread cleaner 106a, but it is to be understood that the threaded pipe cleaning system 100 operates substantially similarly when implemented with the external thread cleaner 106b. Prior to using the threaded pipe cleaning system 100, cleaning fluid may be provided to the fluid pump 128, and the air compressor 108 may be powered by any suitable power source, such as an electrical power source, an internal combustion engine, or the like, for example. The inflatable seal 182 is deflated, such as by discontinuing the supply of pressurized air to the air supply conduit 186 by or substantially preventing pressurized air to flow into the housing 146 by operating the valve 112, for example. A threaded pipe 158 may be oriented with its internal threads 160 positioned proximately to the internal thread cleaner 106a and advanced into the housing 146 such that the end of the threaded pipe 158 at least partially contact the one or more alignment gussets 176.

The valve 112 may be opened to allow pressurized air to flow into the housing 146 via the air conduit 124 and the air supply conduit 186. The inflatable seal 182 is inflated by the pressurized air, such that a substantially fluid impermeable seal is formed around the threaded pipe 158 by the inflatable seal 182. At the same time pressurized air may be routed to the air-jetting ring 188 by the air supply conduit 186 and to the air-jetting head 196 by the air conduit 124. The adjustable airflow restrictor valve 122 may function to ensure sufficient air pressure is available to the inflatable seal 182, for example.

The trigger valve 132 may be actuated to allow high-pressure cleaning fluid to be supplied to the one or more wands 194 via the fluid conduit 130a. In an exemplary embodiment having five wands 194 separated by about 72°, the rotating stem 192 may be rotated about 90° by operating the handle 202 to jet the internal threads 160 of the threaded pipe 158 clean. This step may be repeated one or more times as needed or desired.

During the cleaning operation, the positive air pressure supplied by the air-jetting ring 188 and the air-jetting head 196 substantially prevents cleaning fluid from flowing up the inside and/or outside of the threaded pipe 158 and forces used cleaning fluid to flow towards the drain opening 170 and thus allows the used cleaning fluid along with removed contaminants to be forced out, withdrawn, or otherwise removed from the housing 146 via the drain system 104, for example.

Once the cleaning operation is complete the trigger valve 132 may be actuated to interrupt the supply of high-pressure cleaning fluid to the one or more wand 194. Then the valve 112 may be closed discontinuing the air supply to the air supply conduit 186 which allows for the inflatable seal 182 to deflate and to release the threaded pipe 158 such that the threaded pipe 158 may be removed from the internal thread cleaner 106a. The used cleaning fluid is substantially contained by the threaded pipe cleaning system 100, such that used cleaning fluid does not exit the thread cleaner 106a, and thus does not come into contact with the oilrig or oilfield personnel, for example. Used cleaning fluid, along with any contaminants and/or pipe dope removed from the internal threads 160 may be safely disposed of in any desired manner and in compliance with any applicable environmental regulations, for example.

As will be understood by persons of ordinary skill in the art, the one or more alignment gussets 176 may be replaced with one or more alignment gussets 176 of different size to accommodate a different size threaded pipe 158, for example.

The operation of the external thread cleaner 106b is substantially similar to the operation of the internal thread cleaner 106a. The threaded pipe 158 is advanced into the housing 146 such that the end of the threaded pipe 158 rests against the one or more supporting portions 228 of the one or more internal finger guides 222, and one or more wands 194 are sized such that the external threads 162 may be blasted with cleaning fluid; otherwise the operation of the external thread cleaner 106b is essentially identical to the operation of the internal thread cleaner 106a.

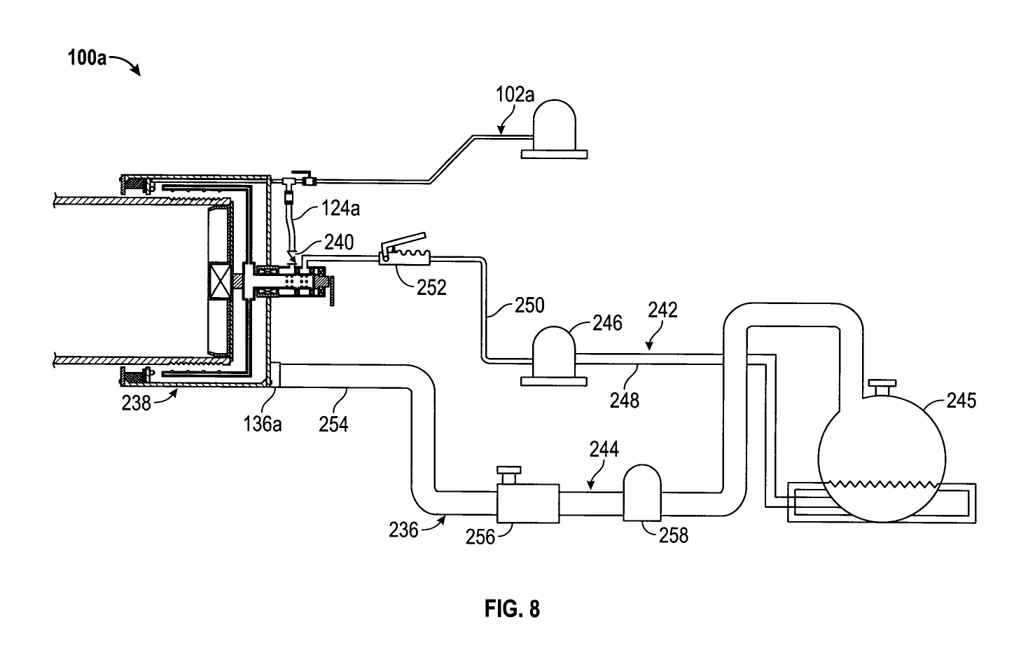

Referring now to FIG. 8, shown therein as an exemplary embodiment of a threaded pipe cleaning system 100a according to the inventive concepts disclosed herein. The threaded pipe cleaning system 100a may be implemented and may function similarly to the threaded pipe cleaning system 100, and includes an air delivery system 102a, a fluid delivery system 236, and a thread cleaner 238.

The air delivery system 102a may be implemented and function similarly to the air delivery system 102 as described above, except that the swivel 126 on the air conduit 124 has been replaced with a check valve 240 on an air conduit 124a of the air delivery system 102a. The check valve 240 functions to prevent cleaning fluid from back flowing into the air conduit 124a as will be described below.

The fluid delivery system 236 may be implemented and may function similarly to the fluid delivery system 103 and the drain system 104 described above, and includes a fluid supply assembly 242 and a drain assembly 244.

The fluid supply assembly 242 includes a cleaning fluid tank 245 and a high-pressure pump 246.

The cleaning fluid tank 245 may be implemented and may function similarly to the holding tank 144 described above, and is fluidly coupled with the high-pressure pump via a fluid suction line 248.

The high-pressure (HP) pump 246 may be implemented as a positive displacement pump, a gear pump, a screw pump, or combinations thereof, and may generate any desired pressure, such as a pressure ranging from about 0 psi to about 5000 psi, or higher. The HP pump 246 draws cleaning fluid from the cleaning fluid tank 245 via the fluid suction line 248 and supplies pressurized cleaning fluid to the thread cleaner 238 as will be described below via a high-pressure fluid conduit 250 (e.g., as half-inch high-pressure flexible hose, or any other conduit configured to withstand high-pressures). The fluid conduit 250 is also fluidly coupled with the thread cleaner 238 as will be described below.

A high-pressure trigger valve 252 (e.g., a manual HP valve or a foot-operated HP valve implemented similarly to the trigger valve 132) is fluidly coupled with the high-pressure fluid conduit 250 downstream from the HP pump 246, and upstream of the thread cleaner 238.

The drain assembly 244 may be implemented similarly to the drain system 104 and includes a coupling 136a fluidly coupled with a housing 146a of the thread cleaner 238 by a male end of the coupling 136a, for example. A female end of the coupling 136a may be fluidly connected with a low-pressure (LP) drain conduit 254, which may be implemented similarly to the drain conduit 138. The LP drain conduit 254 is fluidly coupled with the cleaning fluid tank 245.

A filter assembly 256 is operably and/or fluidly coupled with the LP drain conduit 254 downstream of the coupling 136a and upstream of the cleaning fluid tank 245. The filter assembly 256 may include one, or two or more, filters or filter canisters which are configured to filter out particular matter from the cleaning fluid and which may be connected in series or in parallel to one another, and combinations thereof. Further, in some exemplary embodiments of the inventive concepts disclosed herein, the filter assembly 256 may be omitted. The filter assembly 256 functions to separate solids from the used cleaning fluid, and can optionally include on or more chambers (not shown), impingement plates (not shown), baffles (not shown), clean out access openings (not shown), and combinations thereof, for example. In some exemplary embodiments of the inventive concepts disclosed herein, the filter assembly 256 may include a two-phase or three-phase separator, capable of separating solids, liquids, and/or gasses from one another. Solids separated by the filter assembly 256 may be periodically removed and disposed of in any suitable manner, for example.

A low-pressure pump 258 may be operably and/or fluidly coupled with the LP drain conduit 254 downstream of the filter assembly 256 and upstream of the cleaning fluid tank 245. The LP pump 258 may be implemented similarly to the high-pressure pump 246 and/or similarly to the pump 142, and is configured to draw cleaning fluid from the thread cleaner 238 and thought the filter assembly 256 and to pump the used cleaning fluid into the cleaning fluid tank 245.

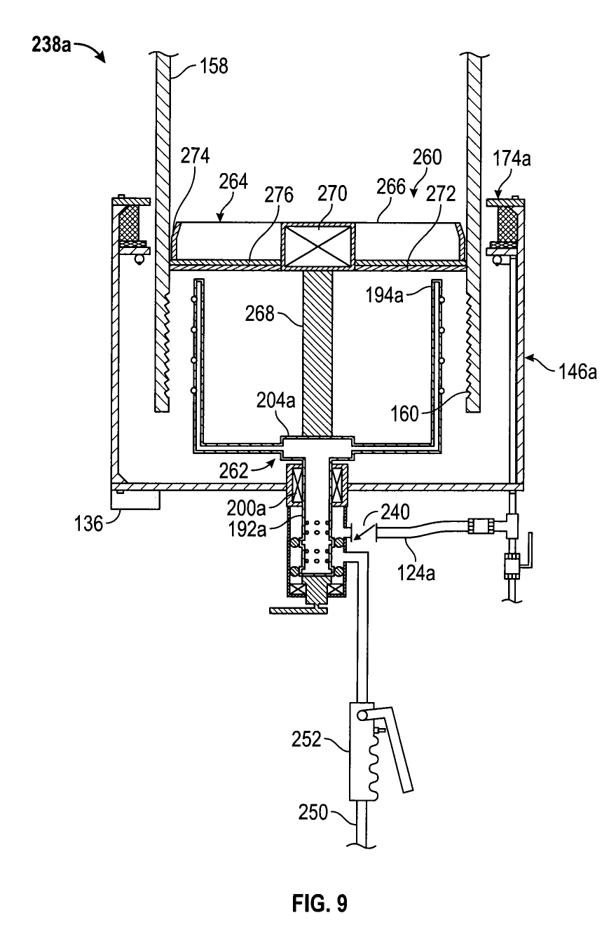

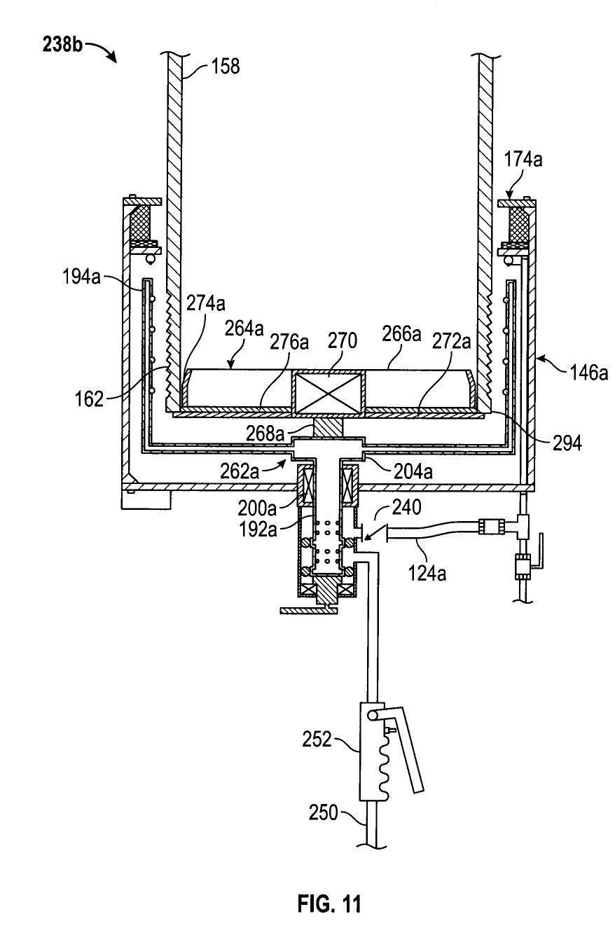

The thread cleaner 238 may be implemented and function similarly to the thread cleaner 106 and may be selectively configured as an internal thread cleaner 238a (FIG. 9) or an external thread cleaner 238b (FIG. 11) as will be described herein below.

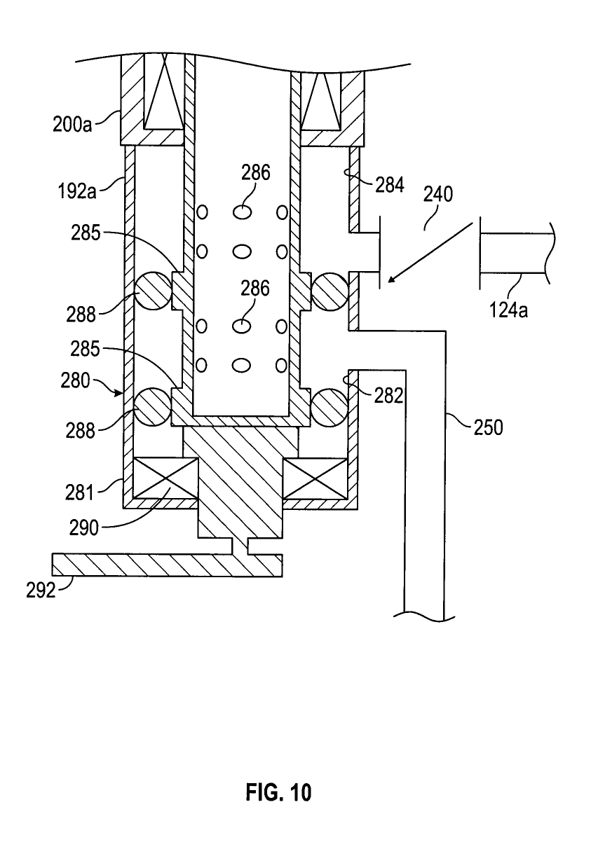

Referring now to FIGS. 9-10, shown therein is an exemplary embodiment of an internal thread cleaner 238a according to the inventive concepts disclosed herein. The internal thread cleaner 238a may be implemented and may function similarly to the internal thread cleaner 106a and may include a housing 146a, a pipe support assembly 260 and a fluid supply assembly 262.

The housing 146a may be implemented and may function similarly to the housing 146 as described above.

The pipe support assembly 260 includes an inflatable seal assembly 174a and an internal sealing assembly 264.

The inflatable seal assembly 174a may be implemented and may function substantially similarly with the inflatable seal assembly 174 and will not be described in detail herein.

The internal sealing assembly 264 extend into the housing 146a and includes a sealing member 266 connected to the fluid supply assembly via a support 268. The sealing member 266 may be connected to the support 268 via a sealed bearing 270 configured to allow the sealing member 266 and the support 268 to rotate relative to one another.

The sealing member 266 includes a flange 272, and is sized and configured such that the sealing member 266 and/or the flange 272 fit snugly inside a threaded pipe 158 (e.g., substantially above or past the internal threads 160) as the threaded pipe 158 is inserted into the housing 146a, and such that the sealing member 266 and the flange 272 cooperate to provide a positive seal against the inside of the threaded pipe 158 so as to prevent cleaning fluid and/or pressurized air from flowing inside the threaded pipe 158.

The sealing member 266 may be constructed of any sufficiently durable material, such as metals, alloys, non-metals, resins, thermoset plastics, thermoplastics, rubber, wood, fibrous materials, and combinations thereof. The sealing member 266 may be sized and shaped to conform to the inside of the threaded pipe 158 and may include a tapered sidewall 274 configured to contact the interior diameter of the threaded pipe 158. Multiple different sizes sealing members 266 may be provided with the thread cleaner 238a so as to fit various size threaded pipes 158.

The flange 272 may be associated with the sealing member 266 in any desired manner, such as via bolts, screws, adhesives, brackets, or combinations thereof, and may be constructed of similar materials as the sealing member 266. In the exemplary embodiment shown in FIG. 9, the flange 272 is shown as extending laterally from the sealing member 266, but it is to be understood that in some exemplary embodiments the flange 272 may sit level or substantially level with the sealing member 266.

An elastomeric seal 276 may be positioned around the sealing member 266 and adjacent to or abutting the flange 272 to provide a positive seal between the sealing member 266 and the threaded pipe 158. The elastomeric seal 276 may be constructed of any desired elastomeric material, such as rubber, plastics, fibrous materials, and combinations thereof, and may be implemented as an O-ring or a gasket, for example.

It is to be appreciated that, in some embodiments, the flange 272 and/or the elastomeric seal 276 may be omitted, and in some exemplary embodiments, the flange 272, the elastomeric seal 276, and/or the sealing member 266 maybe formed as a unitary component.

The support 268 may be implemented as a substantially solid shaft constructed of metals, alloys, aluminum, plastics, resins, non-metals, and combinations thereof, for example, and may have an end connected to the fluid supply assembly 262 as will be described below.

The internal sealing assembly 264 cooperates with the housing 146a to define a path and to stabilize the threaded pipe 158 when the threaded pipe 158 is inserted into the housing 146a, and to substantially seal the interior or inside of the threaded pipe 158 so as to substantially prevent cleaning fluid and/or pressurized air from leaking into the interior of the threaded pipe 158 past the sealing member 266.

As will be appreciated by persons of ordinary skill in the art, the support 268 may be sized and configured such that the pipe support assembly 260 does not extend past the open end of the housing 146a as shown in FIG. 9. However, in some exemplary embodiments, the pipe support assembly 260 may extend at least partially past the housing 146a (e.g., the sealing member 266, the flange 272, and/or the elastomeric seal 276 may extend at least partially past the housing 146a).

The fluid supply assembly 262 may be implemented and may function substantially similarly to the fluid supply assembly 150, and may include a rotating stem 192a, one or more wands 194a.

The rotating stem 192a may be implemented similarly to the rotating stem 192. The rotating stem 192a is substantially hollow and rotatably extends at least partially into the housing 146a, such that a first end of the rotating stem 192a is positioned internally to the housing 146a, and a second end of the rotating stem 192a is positioned externally to the housing 146a. It is to be understood that in some exemplary embodiments, the first end of the rotating stem 192a does not extend into the threaded pipe 158 when the threaded pipe is advanced or otherwise inserted into the housing as shown in FIG. 9.

An optional sealed bearing 200a may be implemented to ensure smooth rotation of the rotating stem 192a about the housing 146a, while maintaining a substantially fluid-impermeable connection between the housing 146a and the rotating stem 192a, for example. The optional sealed bearing 200a may be implemented similarly to the sealed bearing 200.

A substantially cylindrical hub 204a may be attached to, or otherwise associated with the rotating stem 192a and is fluidly coupled with the rotating stem 192a. The hub 204a may be implemented similarly to the hub 204. The hub 204a may be connected or otherwise associated with the support 268 in any desired manner, such as bolts, screws, brackets, adhesives, and combinations thereof. As will be appreciated by persons of ordinary skill in the art having the benefit of the instant disclosure when the rotating stem 192a and the hub 204a are rotated, the support 268 rotates relative to the sealing member 266 to allow rotation of the rotating stem 192a without rotating the sealing member 266 and/or the threaded pipe 158. In some exemplary embodiments, the hub 204a and the support 268 may be removable connected to one another so that the support 268 may be selectively connected with and disconnected with the hub 204a. It is to be understood that in some exemplary embodiments, the hub 204a does not extend into the threaded pipe 158 when the threaded pipe is advanced or otherwise inserted into the housing as shown in FIG. 9.

One or more wand 194a may extend from the hub 204a, such that the one or more wand 194a is in fluid communication with the hub 204a and/or with the rotating stem 192a. The one or more wand 194a may be implemented and may function similarly to the wand 194 and is configured to emit, jet, blast, or otherwise provide a volume of cleaning fluid and/or pressurized gas onto the internal threads 160 of the threaded pipe 158, when the threaded pipe is inserted into the housing 146a.

A fluid manifold 280 is rotatably associated with the second end of the rotating stem 192a and is fluidly coupled with the rotating stem 192a and with the hub 200a. As shown in FIG. 10, the fluid manifold 280 includes a housing 281 through which the rotating stem 192a rotatably extends, a cleaning fluid chamber 282 fluidly coupled with the high-pressure conduit 250, and an air chamber 284 fluidly coupled with the air conduit 124a. The cleaning fluid chamber 282 and the air chamber 284 may be defined by flanges 285 extending from the rotating stem 192a cooperating with the housing 281, and are fluidly coupled with the interior of the rotating stem 192a and with the hub 204a via one or more openings 286. Cleaning fluid and pressurized air may flow from the cleaning fluid chamber 282 and the air chamber 284 into the hub 204a and through the wands 194a as will be described below. Sealing members 288 may be implemented between the flanges 285 and the housing 281 to separate the cleaning fluid chamber 282 and the air chamber 284.

A first end of the fluid manifold 280 is coupled with the housing 146a (e.g., with the sealed bearing 200a), and a sealed bearing 290 may be implemented to rotatably couple a second end of the fluid manifold 280 to the rotating stem 192a, such that the second end of the rotating stem 192a extends at least partially past the fluid manifold 280.

A handle 292 can be associated with the end of the rotating stem 192a extending past the fluid manifold 280, and is configured to allow a user to rotate the rotating stem 192a relative to the housing 146a and/or to the fluid manifold 280, for example. In some exemplary embodiments, the handle 292 may be rotatable from about 0° to about 720°, for example, while in some exemplary embodiments the handle 292 may be rotatable to any desired number of degrees or revolutions of the rotating stem 192a relative to the housing 146a. The handle 292 may be manually operated, mechanically operated, electronically operated, hydraulically operated, pneumatically operated, remotely controlled, and combination thereof, for example.

The operation of the internal thread cleaner 238a may be similar to the operation of the internal thread cleaner 106a, and may proceed as follows. The threaded pipe 158 may be at least partially inserted into the housing 146a such that the sealing member 266 is positioned at least partially inside the threaded pipe 158 and substantially above the internal threads 160 (FIG. 9) and forms a positive seal with the inside of the threaded pipe 158. The inflatable seal assembly 174a may be activated to seal around the outside of the threaded pipe 158 as described above. An operator or user may activate the trigger valve 252 (e.g., a foot operated valve) to supply high-pressure cleaning fluid to the fluid manifold 280 and to the wands 194a. The user or operator may rotate the handle 292 to rotate the rotating stem 192a, the hub 204a, and the wands 194a, to blast cleaning fluids and gas at the internal threads 160 of the threaded pipe 158. At the same time, the sealing member 266 may remain stationary (by allowing the support 268 to rotate in the sealed bearing 270), and may cooperate with the inflatable seal assembly 174a to substantially seal the inside and the outside of the threaded pipe 158, so that substantially no cleaning fluid flows inside the threaded pipe 158 and outside of the housing 146a. The handle 292 may be rotated any desired number of rotations or to any desired degrees (e.g., 0° to 720°) to clean the internal threads 160 of the threaded pipe 158. The check valve 240 functions to prevent the high-pressure cleaning fluid from flowing into the air conduit 124a.

The low-pressure pump 258 may be activated to draw used cleaning fluid from the housing 146a via the coupling 136a, and to move the used cleaning fluid through the filer assembly 256 and back into the cleaning fluid tank 245.

At any desired time, the user or operator can discontinue supplying cleaning fluid to the fluid manifold 280, and may supply pressurized air to the fluid manifold 280 and to the wands 194a via the air conduit 124a. The operator may rotate the handle 292 so as to substantially dry the internal threads 160 and/or to blow off any remaining cleaning fluid and/or debris or contaminants from the internal threads 160 and/or from the housing 146a (e.g., via the coupling 136a). Once the internal threads 160 are sufficiently dried, the inflatable seal assembly 174a may be deactivated, and the threaded pipe may be withdrawn from the housing 146a.

Referring now to FIG. 11, shown therein is an exemplary embodiment of an external thread cleaner 238b. The external thread cleaner 238b may be implemented and may function substantially similarly to the internal thread cleaner 238a and/or the external thread cleaner 106b. The external thread cleaner 238b includes a sealing member 266a which may be implemented similarly to the sealing member 266. In some exemplary embodiments, the sealing member 266a may be configured to be inserted partially inside the threaded pipe 158, such that the end 294 of the threaded pipe 158 rests against the elastomeric seal 276a and/or the flange 272a (e.g., the flange 272a and/or the elastomeric seal 276a are not inserted into the threaded pipe 158). Further, in some exemplary embodiments the sealing member 266a may be sized and configured so that the sealing member 266a may be substantially completely inserted inside the threaded pipe 158 (e.g., partially or completely above the external threads 162). As will be appreciated by persons of ordinary skill in the art, the sealing members 266 and 266a may be interchangeable for different size of threaded pipes 158.

The sealing member 266a may be associated with a rotating hub 204a via a support 268a which may be shorter than the support 268, and may be implemented such that an end 294 of the threaded pipe 158 may abut of otherwise be adjacent to an elastomeric seal 276a and/or a flange 272a of the sealing member 266a. In some exemplary embodiments, the support 268a may be omitted, and the sealing member 266a may be rotatably associated with the hub 204a via a sealed bearing 270.

The operation of the external thread cleaner 238b is substantially similar to the operation of the internal thread cleaner 238a, except that the sealing member 266a may be inserted into the threaded pipe 158 such that the elastomeric seal 276a and/or the flange 272a about or are positioned adjacent to the end 294 of the threaded pipe 158.

The cleaning fluid may be recirculated through the pipe thread cleaning system 100a as many times as desired, depending on contaminant load of the internal threads 160 and/or the external threads 162 cleaned by the pipe cleaning system 100a, for example.

As it will be appreciated by persons of ordinary skill in the art, changes may be made in the construction and the operation of the various components, elements and assemblies described herein or in the steps or the sequence of steps of the methods described herein without departing from the broad scope of the inventive concepts disclosed herein.

From the above description, it is clear that the inventive concepts disclosed herein are well adapted and/or configured to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the scope and coverage of the inventive concepts disclosed and claimed herein.

What is claimed is:

1. A pipe thread cleaning system, comprising:
an air delivery system configured to deliver a volume of pressurized gas;
a fluid delivery system configured to deliver a volume of pressurized fluid; and
a thread cleaner, comprising:
a housing having an open end, a closed end, and a sidewall; and
a pipe support assembly including an inflatable seal associated with the open end of the housing and fluidly coupled with the air delivery system, the inflatable seal configured to substantially seal against an exterior of a threaded pipe when the threaded pipe is advanced into the housing;
a fluid supply assembly including:
a rotating stem extending through the closed end of the housing and having a first end positioned inside the housing and having a hub associated therewith and fluidly coupled with the fluid delivery system, and a second end positioned at least partially outside of the housing;
at least one wand fluidly coupled with the hub and having a first portion extending substantially radially from the hub, and a second portion extending substantially parallel to the sidewall, the second portion including at least one jet opening configured to direct a volume of cleaning fluid onto threads of the threaded pipe when the threaded pipe is advanced into the housing; and
a handle associated with the second end of the rotating stem and configured to rotate the rotating stem relative to the housing so as to rotate the hub and the at least one wand relative to the threads of the threaded pipe when the threaded pipe is advanced in the housing such that the at least one wand directs a volume of cleaning fluid towards substantially an entire surface of the threads of the threaded pipe.

2. The system of claim 1, wherein the fluid supply assembly further comprises an air conduit fluidly coupled with the air delivery system and extending at least partially past the first end of the rotating stem, the air conduit having an air-jetting head configured to extend into the threaded pipe when the threaded pipe is advanced into the housing, the air-jetting head having one or more air jetting openings configured to jet a volume of pressurized gas towards the closed end of the housing.

3. The system of claim 1, wherein the pipe support assembly further comprises an air jetting ring positioned below the inflatable seal and fluidly coupled with the air delivery system, the air jetting ring having at least one air-jetting outlet configured to jet a volume of pressurized gas towards the closed end of the sidewall.

4. The system of claim 1, wherein the pipe support assembly further comprises at least one support gusset positioned inside the housing and configured to support and end of the threaded pipe when the threaded pipe is advance into the housing.

5. The system of claim 1, wherein the pipe support assembly further comprises an alignment spider assembly including at least one internal finger guide having:
a parallel portion configured to be inserted at least partially into the threaded pipe when the threaded pipe is advanced into the housing and having a support portion configured to support and end of the threaded pipe; and
a radial portion rotatably associated with the rotating stem.

6. The system of claim 5, wherein the radial portion is an adjustable-length radial portion.

7. The system of claim 1, wherein the pipe support assembly further comprises an internal sealing assembly having a support connected to the hub, and a seal member rotatably connected to the support and configured to be at least partially inserted into the threaded pipe as the threaded pipe is advanced into the housing so as to substantially seal an interior of the threaded pipe.

8. The system of claim 7, wherein the sealing member includes a sidewall, a flange extending laterally from the sidewall, and an elastomeric seal positioned adjacent to the flange.

9. The system of claim 8, wherein the internal sealing assembly extends past the open end of the sidewall.

10. The system of claim 1, wherein the rotating stem includes a fluid manifold coupled with the second end thereof, the fluid manifold including and air chamber fluidly coupled with the air delivery system, and a cleaning fluid chamber fluidly coupled with the fluid delivery system, the fluid manifold fluidly coupled with the hub and with the at least one wand such that at least one of a volume of pressurized cleaning fluid and a volume of pressurized gas flows through the at least one wand.

11. The system of claim 10, wherein the air chamber is fluidly coupled with the air delivery system via a check valve.

12. The system of claim 1, wherein the housing further includes a drain configured to drain a volume of cleaning fluid from the housing.

13. The system of claim 12, wherein the drain is fluidly coupled with the fluid delivery system.

14. The system of claim 1, wherein the rotating stem is rotatable relative to the housing between about 0° and about 720°.

15. A method of cleaning pipe threads, comprising:
advancing a threaded pipe having threads into an open end of a housing and towards a closed end of the housing;
inflating an inflatable seal associated with a sidewall of the housing adjacent to the open end such that the inflatable seal substantially seals against an exterior of the threaded pipe;
jetting a volume of pressurized cleaning fluid towards the threads of the threaded pipe via at least one jet opening of at least one wand extending substantially parallel to the sidewall of the housing;
rotating the at least one wand relative to the threads by rotating a rotatable stem assembly having a rotatable hub associated with a first end thereof and with the at least one wand, and a second end extending at least partially outside the closed end of the housing and having a handle, wherein the at least one wand is fluidly coupled with the hub and the hub is fluidly coupled with a cleaning fluid delivery system and a gas delivery system;
draining the volume of pressurized cleaning fluid via a drain fluidly coupled with the housing; and
jetting a volume of pressurized gas towards the threads via the at least one wand so as to substantially dry the threads and to enhance cleaning fluid drainage via the drain.

16. The method of claim 15, wherein the step of rotating the at least one wand includes rotating the at least one wand between about 0° and about 720° relative to the threads so as to direct pressurized cleaning fluid toward substantially an entire surface of the threads.

17. The method of claim 15, further comprising inserting an internal sealing assembly at least partially into an interior of the threaded pipe such that the internal sealing assembly substantially seals the interior of the threaded pipe so as to substantially prevent pressurized cleaning fluid and pressurized gas from flowing into the interior of the threaded pipe and past the internal sealing assembly.

18. The method of claim 15, further comprising jetting a volume of pressurized air via an air-jetting ring associated with the sidewall below the inflatable seal and fluidly coupled with an air delivery system, so that the volume of pressurized gas moves along the threaded pipe and towards the closed end of the housing so as to generate a positive pressure inside the housing.

19. The method of claim 18, further comprising jetting a volume of pressurized gas towards the closed end of the housing via an air jetting opening of an air jetting head supported by an air conduit extending through the rotating stem such that the air jetting head is at least partially positioned inside the threaded pipe, so that pressurized cleaning fluid is substantially prevented from flowing inside the threaded pipe.
